(19) United States
(12) Patent Application Publication
(10) Pub. No.: US 2013/0044096 A1
(43) Pub. Date: Feb. 21, 2013

(54) METHOD OF DRIVING DISPLAY PANEL AND DISPLAY APPARATUS FOR PERFORMING THE SAME

(71) Applicants: Kwi-Hyun Kim, Suwon-si (KR); Kook-Hyun Choi, Seoul (KR); Sang-Ki Kwak, Asan-si (KR)

(72) Inventors: Kwi-Hyun Kim, Suwon-si (KR); Kook-Hyun Choi, Seoul (KR); Sang-Ki Kwak, Asan-si (KR)

(21) Appl. No.: 13/443,549

(22) Filed: Apr. 10, 2012

(30) Foreign Application Priority Data
Aug. 18, 2011 (KR) 2011-0081953

(51) Int. Cl. G09G 5/00; G09G 3/36

(52) U.S. Cl. 345/211; 345/87

(57) ABSTRACT

A method of driving a display panel includes generating a clock signal including a high period which includes a first horizontal period having a first level, a second horizontal period having a second level smaller than the first level, and a third horizontal period having the first level, and a low period having a third level, generating a gate signal which includes the first level in the first horizontal period, the second level in the second horizontal period, and the first level in the third horizontal period based on the clock signal, and charging a data voltage to a pixel of the display panel in response to the gate signal.

### CROSS-REFERENCE TO RELATED APPLICATION

This application claims priority under 35 U.S.C. §119 to Korean Patent Application No. 2011-0081953, filed on Aug. 18, 2011 in the Korean Intellectual Property Office KIPO, the contents of which are herein incorporated by reference in their entireties.

### BACKGROUND

1. Technical Field

Exemplary embodiments of the present invention relate to a method of driving a display panel and a display apparatus for performing the method of driving the display panel. More particularly, exemplary embodiments of the present invention relate to a method of driving a display panel to increase the display quality of the display panel and a display apparatus for performing the method.

2. Discussion of the Related Art

Generally, a liquid crystal display (LCD) apparatus includes an LCD panel displaying an image using a light transmittance of liquid crystal and a backlight assembly disposed under the LCD panel and providing light to the LCD panel.

The LCD panel includes a plurality of data lines, a plurality of gate lines crossing the data lines, and a plurality of pixels electrically connected to the data lines and the gate lines. Each of the pixels includes a thin film transistor (TFT) connected to a corresponding data line of the data lines and a corresponding gate line of the gate lines, and a liquid crystal (LC) capacitor connected to the TFT.

The TFT charges a data voltage applied through the data line to the LC capacitor in response to a gate signal applied to the gate line.

The data voltage is preset corresponding to a grayscale of an image displayed on the pixel. Thus, arrangement angles of the LC molecules included in the LC capacitor are controlled based on a level of the data voltage charged to the LC capacitor so that the LC capacitor controls a transmittance of light generated from a backlight unit to display the grayscale of the image. Therefore, a charging rate of the LC capacitor is an important factor to determine a display quality of the image displayed on the LCD apparatus.

### SUMMARY

Exemplary embodiments of the present invention provide a method of driving a display panel capable of increasing a charging rate to enhance a display quality and a display apparatus for performing the method.

According to an exemplary embodiment of the present invention, there is provided a method of driving a display panel. The method includes generating a clock signal including high period which includes a first horizontal period having a first level, a second horizontal period having a second level smaller than the first level, and a third horizontal period having the first level, and a low period having a third level, generating a gate signal which includes the first level in the first horizontal period, the second level in the second horizontal period, and the first level in the third horizontal period based on the clock signal, and charging a data voltage to a pixel of the display panel in response to the gate signal.

According to an exemplary embodiment, the first, second, and third horizontal periods are different from each other.

According to an exemplary embodiment, the second horizontal period is the shortest of the first, second, and third horizontal periods.

According to an exemplary embodiment, the second level includes at least one level between the first level and the third level.

According to an exemplary embodiment, the second level and the third level are equal to each other.

According to an exemplary embodiment, a middle part of the gate signal includes a U shape.

According to an exemplary embodiment, a middle part of the gate signal includes a V shape.

According to an exemplary embodiment, charging the data voltage includes charging a previous data voltage corresponding to a previous horizontal period to the pixel in response to the first level of the gate signal during the first horizontal period, maintaining the previous data voltage charged to the pixel the pixel in response to the second level of the gate signal during the second horizontal period, and charging a self data voltage to the pixel in response to the first level of the gate signal during the third horizontal period.

According to an exemplary embodiment, charging the data voltage includes charging a self data voltage to the pixel in response to the first level of the gate signal during the first horizontal period, maintaining the self data voltage charged to the pixel in response to the second level of the gate signal during the second horizontal period, and recharging the self data voltage to the pixel in response to the first level of the gate signal during the third horizontal period.

According to an exemplary embodiment of the present invention, there is provided a display apparatus. The display apparatus includes a clock generating part generating a clock signal including a high period which includes a first horizontal period having a first level, a second horizontal period having a second level smaller than the first level and a third horizontal period having the first level, and a low period having a third level, a gate driving part generating a gate signal which includes the first level in the first horizontal period, the second level in the second horizontal period and the first level in the third horizontal period in synchronization with the clock signal, and a display panel including a plurality of pixels arranged in a matrix shape, each of the pixels including a switching element connected to a data line and a gate line. The switching element charges a data voltage to a liquid crystal (LC) capacitor in response to the gate signal.

According to an exemplary embodiment, the data line is disposed between a first pixel column and a second pixel column adjacent to the first pixel column, and alternately connected to pixels of the first pixel column and pixels of the second pixel column.

According to an exemplary embodiment, at least one of the first, second, and third horizontal periods is different from the other periods of the first, second, and third horizontal periods.

According to an exemplary embodiment, the second horizontal period is the shortest of the first, second, and third horizontal periods.

According to an exemplary embodiment, the second level may include at least one level which is smaller than the first level and equal to or larger than the third level.

According to an exemplary embodiment, a middle part of the gate signal includes at least one of a U shape and a V shape.

According to an exemplary embodiment, the clock generating part may generate a first clock signal which includes a first high period including the first, second, and third horizontal periods and a first low period having the third level, a second clock signal which includes a second high period including the first, second, and third horizontal periods and a second low period having the third level, the second high period overlapping part of the first high period, a third clock signal which includes a third high period including the first, second, and third horizontal period and a third low periods having the third level, the third high period overlapping part of the second high period, a fourth clock signal which includes a fourth high period including the first, second, and third horizontal periods and a fourth low period having the third level, and the fourth high period overlapping part of the third high period and corresponding to the first low period, a fifth clock signal which includes a fifth high period including the first, second, and third horizontal periods and a fifth low period having the third level, and the fifth high period overlapping part of the fourth high period and corresponding to the second low period, and a sixth clock signal which includes a sixth high period including the first, second, and third horizontal periods and a sixth low period having the third level, the sixth high period overlapping part of the fifth high period and corresponding to the third low period.

According to an exemplary embodiment, the pixel is charged with a previous data voltage corresponding to a previous horizontal period in response to the first level of the gate signal during the first horizontal period, maintains the charged previous data voltage in response to the second level of the gate signal during the second horizontal period, and is charged with a self data voltage in response to the first level of the gate signal during the third horizontal period.

According to an exemplary embodiment, the clock generating part generates a first clock signal which includes a first high period including the first, second and third horizontal period and a first low period having the third level, and a second clock signal which includes a second high period including the first, second, and third horizontal period and a second low period having the third level. The second high period overlaps part of the first high period and corresponds to the first low period.

According to an exemplary embodiment, the pixel is charged with a self data voltage in response to the first level of the gate signal during the first horizontal period, maintains the charged self data voltage in response to the second level of the gate signal during the second horizontal period, and is recharged with the self data voltage in response to the first level of the gate signal during the third horizontal period.

According to an embodiment, there is provided a display apparatus including a gate driving part generating a gate signal during a high period and a low period, wherein the high period includes first, second, and third horizontal periods, and the gate signal includes a first level during the first horizontal period, a second level during the second horizontal period, the first level during the third horizontal period, and a third level during the low period, wherein the second level is lower than the first level, and the third level is lower than the second level, and a display panel including a plurality of pixels, wherein at least one of the pixels is connected to a data line and a gate line and is pre-charged with a data voltage from the data line during the first horizontal period, maintains the pre-charged data voltage during the second horizontal period, and is recharged with the data voltage during the third horizontal period in response to the gate signal from the gate line.

According to the embodiments of the present invention, a data voltage smaller than the self data voltage may be prevented from being charged to the pixel during a pre-charging period so that the charging rate of the self data voltage may be increased. In addition, the gate signal includes the time-modulated level so that the charging rate of the display panel may be uniform.

### BRIEF DESCRIPTION OF THE DRAWINGS

The embodiments of the present invention will become more apparent by the following detailed description with reference to the accompanying drawings, in which:

FIG. 1 is a plan view illustrating a display apparatus according to an exemplary embodiment of the present invention;

FIG. 2 is a waveform diagram illustrating a clock signal generated from a clock generating part as shown in FIG. 1;

FIG. 3 is a block diagram illustrating a gate driving part as shown in FIG. 1;

FIGS. 4A and 4B are schematic diagrams for describing a charging rate of a pixel when a fall white pattern is displayed on a display panel as shown in FIG. 2;

FIGS. 5A and 5B are schematic diagrams for describing a charging rate of a pixel when a color pattern is displayed on a display panel as shown in FIG. 2;

FIG. 6 is a waveform diagram illustrating a clock signal generated from a clock generating part according to an exemplary embodiment of the present invention;

FIG. 7 is a waveform diagram illustrating a charging rate of a pixel according to the clock signal of FIG. 6;

FIG. 8 is a waveform diagram illustrating a clock signal generated from a clock generating part according to an exemplary embodiment of the present invention;

FIG. 9 is a waveform diagram illustrating a charging rate of a pixel according to the clock signal of FIG. 8;

FIG. 10 is a waveform diagram illustrating a clock signal generated from a clock generating part according to an exemplary embodiment of the present invention;

FIG. 11 is a block diagram illustrating the gate driving part of FIG. 10; and

FIG. 12 is a waveform diagram illustrating a charging rate of a display panel according to the clock signal of FIG. 10.

### DETAILED DESCRIPTION OF THE EMBODIMENTS

Hereinafter, the embodiments of the present invention will be described in detail with reference to the accompanying drawings.

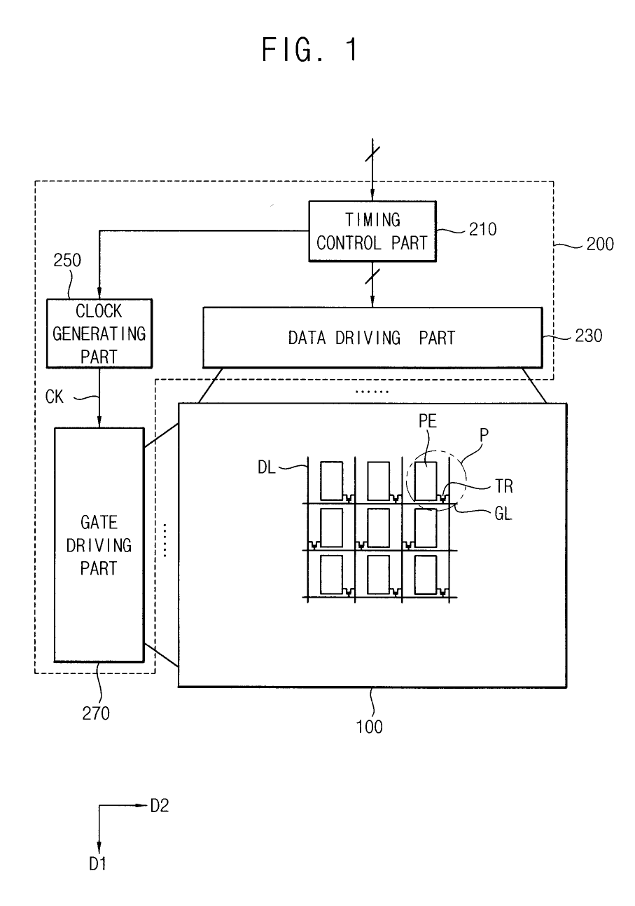

FIG. 1 is a plan view illustrating a display apparatus according to an exemplary embodiment of the present invention.

Referring to FIG. 1, the display apparatus includes a display panel 100 and a panel driving part 200.

The display panel 100 includes a plurality of data lines DL, a plurality of gate lines GL, and a plurality of pixels P. The data lines DL extend along a first direction D1 and are arranged along a second direction D2 crossing the first direction D1. The gate lines GL extend along the second direction D2 and are arranged along the first direction D1. The pixels P are arranged in a matrix shape including a plurality of pixel columns and a plurality of pixel rows. Each pixel P includes a switching element TR connected to a data line DL and a gate line GL and a pixel electrode PE connected to the switching element TR. Each data line DL is disposed between two pixel columns adjacent to each other and is alternately connected in a zigzag pattern to pixels included in the adjacent pixel columns. In other words, each data line DL is connected to every two pixels in a pixel column adjacent to the data line DL. Thus, pixels included in one pixel column may be driven by two data lines adjacent to each other.

The panel driving part 200 includes a timing control part 210, a data driving part 230, a clock generating part 250, and a gate driving part 270.

The timing control part 210 receives a synchronization signal and image data. The synchronization signal includes a vertical synchronization signal, a horizontal synchronization signal, a master clock signal, etc. The timing control part 210 corrects the image data using various correction algorithms. For example, various correction algorithms include an adaptive color correction (ACC) algorithm for equalizing a white level of the image data and a dynamic capacitance compensation (DCC) algorithm correcting the image data of a present frame based on the image data of a previous frame for reducing a response time.

The data driving part 230 converts the image data received from the timing control part 210 to a data voltage of an analog type and outputs the data voltage to the display panel 100.

The clock generating part 250 generates at least one clock signal CK to drive the gate driving part 270 based on the synchronization signal received from the timing control part 210. The clock signal CK includes a high period corresponding to 3 horizontal periods (3H) and a low period corresponding to three horizontal periods (3H). The horizontal period H may be the same or substantially the same as one cycle of the horizontal synchronization signal. The high period of the clock signal CK includes a first horizontal period having a first level, a second horizontal period having a second level, and a third horizontal period having the first level. The second level is smaller than the first level.

The gate driving part 270 generates a gate signal in synchronization with the high period of the clock signal CK received from the clock generating part 250. Thus, the gate signal includes a first horizontal period having the first level, a second horizontal period having the second level, and a third horizontal period having the first level. Based on the first, second, and third horizontal periods, the pixel is pre-charged with a previous data voltage corresponding to a previous horizontal period during the first and second horizontal periods and is charged with a self data voltage during the third horizontal period. The term “self data voltage” refers to the data voltage which is not a previous data voltage, and is the data voltage which is assigned for a particular pixel.

The gate driving part 270 includes a plurality of transistors formed in a peripheral area of the display panel 100. The transistors are formed via the same or substantially the same process as a process of forming a switching element TR of the pixel. Alternatively; the gate driving part 270 is mounted in the peripheral area in a chip type. Alternatively, the gate driving part 270 includes a flexible printed circuit board (FPCB) on which the chip is mounted, such as a tape carrier package (TCP).

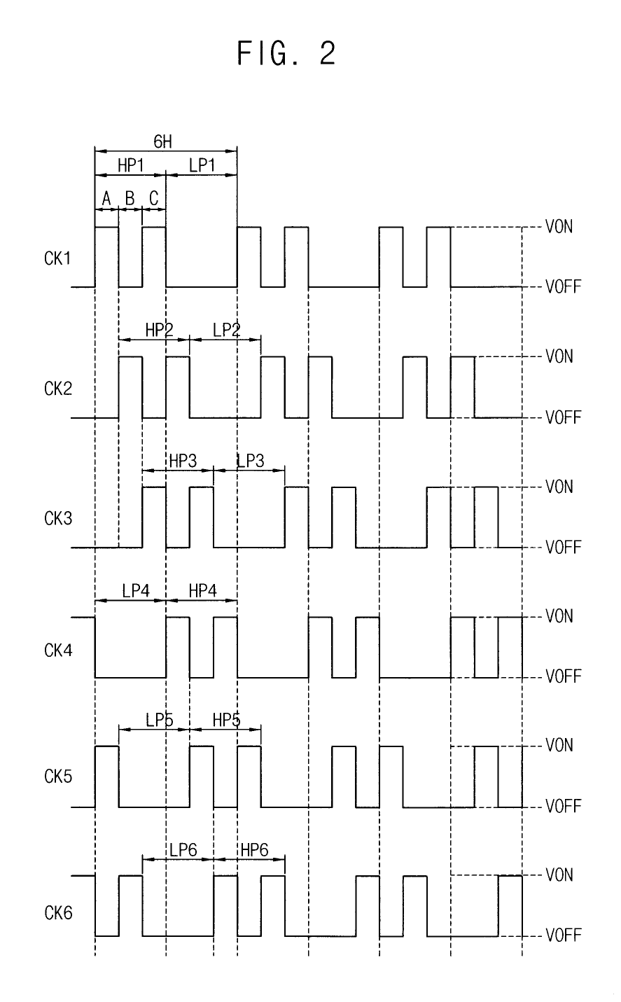

FIG. 2 is a waveform diagram illustrating clock signals generated from a clock generating part as shown in FIG. 1.

Referring to FIGS. 1 and 2, the clock generating part 250 generates a first clock signal CK1, a second clock signal CK2, a third clock signal CK3, a fourth clock signal CK4, a fifth clock signal CK5, and a sixth clock signal CK6.

The first clock signal CK1 includes a first high period HP1 and a first low period LP1. The first high period HP1 includes a first horizontal period A, a second horizontal period B, and a third horizontal period C. The first, second, and third horizontal periods A, B, and C have the same length or different lengths from each other. For example, the third horizontal period C is longer than the first horizontal period A and the second horizontal period B is shorter than the first horizontal period (C>A>B).

The first clock signal CK1 has a first level that is a high voltage VON in the first horizontal period A, a second level that is a low voltage VOFF in the second horizontal period B, and the first level that is the high voltage VON in the third horizontal period C. The first clock signal CK1 has the second level that is the low voltage VOFF during the first low period LP1. The high voltage VON has a level for turning on the switching element TR in the pixel, and the low voltage VOFF has a level for turning off the switching element TR in the pixel.

The second clock signal CK2 includes a second high period HP2 and a second low period LP2. The second high period HP2 includes the first, second, and third horizontal periods A, B, and C. The second clock signal CK2 has the first level of the high voltage VON, the second level of the low voltage VOFF, and the first level of the high voltage VON during the first, second, and third horizontal periods A, B, and C, respectively. The first and second horizontal periods A and B of the second clock signal CK2 respectively overlap the second and third horizontal periods B and C of the first clock signal CK1. The third horizontal period C of the second clock signal CK2 overlaps part of the first low period LP1 of the first clock signal CK1.

The third clock signal CK3 includes a third high period HP3 and a third low period LP3. The third high period HP3 includes the first, second, and third horizontal periods A, B and C. The third clock signal CK3 has the first level of the high voltage VON, the second level of the low voltage VOFF, and the first level of the high voltage VON during the first, second, and third horizontal periods A, B, and C, respectively. The first and second horizontal periods A and B of the third clock signal CK3 overlaps the second and third horizontal periods B and C of the second clock signal CK2. The third horizontal period C of the third clock signal CK3 overlaps part of the second low period LP2 of the second clock signal CK2.

The fourth clock signal CK4 includes a fourth high period HP4 and a fourth low period LP4. The fourth high period HP4 includes the first, second, and third horizontal periods A, B, and C. The fourth clock signal CK4 has the first level of the high voltage VON, the second level of the low voltage VOFF, and the first level of the high voltage VON during the first, second, and third horizontal periods A, B and C, respectively. The first and second horizontal periods A and B of the fourth clock signal CK4 respectively overlap the second and third horizontal periods B and C of the third clock signal CK3. The third horizontal period C of the fourth clock signal CK4 overlaps part of the third low period LP3 of the third clock signal CK3. The fourth high period HP4 and the fourth low period LP4 respectively correspond to the first low period LP1 and the first high period HP1 of the first clock signal CK1.

The fifth clock signal CK5 includes a fifth high period HP5 and a fifth low period LP5. The fifth high period HP5 includes the first, second, and third horizontal periods A, B, and C. The fifth clock signal CK5 has the first level of the high voltage VON, the second level of the low voltage VOFF, and the first level of the high voltage VON during the first, second, and third horizontal periods A, B, and C, respectively. The first and second horizontal periods A and B of the fifth clock signal CK5 respectively overlap the second and third horizontal periods B and C of the fourth clock signal CK4. The third horizontal period C of the fifth clock signal CK5 overlaps part of the fourth low period LP4 of the fourth clock signal CK4. The fifth high period HP5 and the fifth low period LP5 respectively correspond to the second low period LP2 and the second high period HP2 of the second clock signal CK2.

The sixth clock signal CK6 includes a sixth high period HP6 and a sixth low period LP6. The sixth high period HP6 includes the first, second, and third horizontal periods A, B, and C. The sixth clock signal CK6 has the first level of the high voltage VON, the second level of the low voltage VOFF, and the first level of the high voltage VON during the first, second, and third horizontal periods A, B, and C, respectively. The first and second horizontal periods A and B of the sixth clock signal CK6 respectively overlap the second and third horizontal periods B and C of the fifth clock signal CK5. The third horizontal period C of the sixth clock signal CK6 overlaps part of the fifth low period LP5 of the fifth clock signal CK5. The sixth high period HP6 and the sixth low period LP6 respectively correspond to the third low period LP3 and the third high period HP3 of the third clock signal CK3.

According to an exemplary embodiment, a middle part of each clock signal includes a U shape with a first depth. The first depth corresponds to a voltage difference between the high voltage VON and the low voltage VOFF of the clock signal. As shown in FIG. 2, the U shape includes straight lines connected to each other.

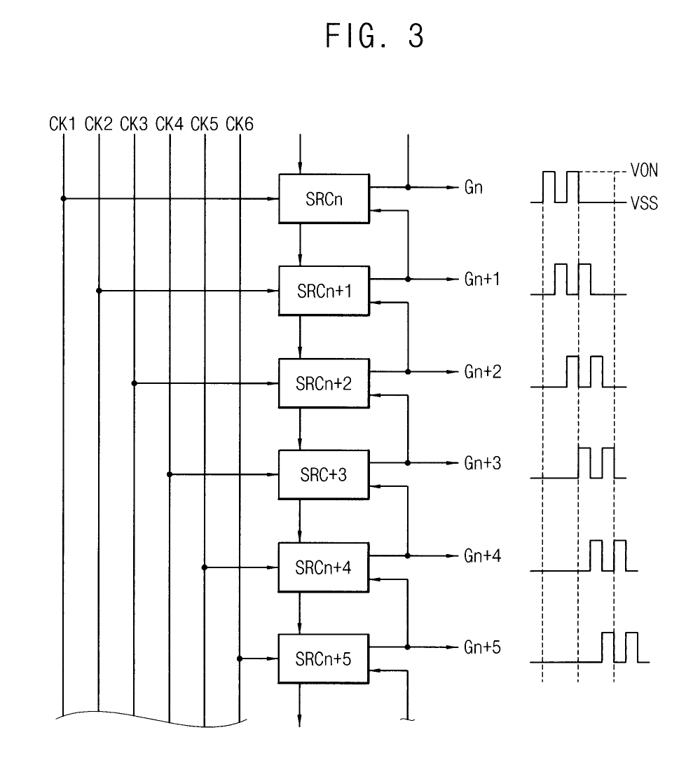

FIG. 3 is a block diagram illustrating the gate driving part of FIG. 1.

Referring to FIGS. 1, 2, and 3, the gate driving part 270 includes a plurality of stages sequentially outputting a plurality of gate signals.

For example, the gate driving part 270 includes an n-th stage SRCn, an (n+1)-th stage SRCn+1, an (n+2)-th stage SRCn+2, an (n+3)-th stage SRCn+3, an (n+4)-th stage SRCn+4, and an (n+5)-th stage SRCn+5 (n is a natural number).

The n-th stage SRCn receives the first clock signal CK1 and outputs the first clock signal CK1 of the first high period HP1 as an n-th gate signal Gn in response to a gate signal from a previous stage or a vertical starting signal.

The (n+1)-th stage SRCn+1 receives the second clock signal CK2 and outputs the second clock signal CK2 of the second high period HP2 as an (n+1)-th gate signal Gn+1 in response to the n-th gate signal Gn. The (n+1)-th gate signal Gn+1 overlaps part of the n-th gate signal Gn. For example, the (n+1)-th gate signal Gn+1 of first and second horizontal periods overlaps the n-th gate signal Gn.

The (n+2)-th stage SRCn+2 receives the third clock signal CK3 and outputs the third clock signal CK3 of the third high period HP3 as an (n+2)-th gate signal Gn+2 in response to the (n+1)-th gate signal Gn+1. For example, the (n+2)-th gate signal Gn+2 of first and second horizontal periods overlaps the (n+1)-th gate signal Gn+1.

The (n+3) stage SRCn+3 receives the fourth clock signal CK4 and outputs the fourth clock signal CK4 of the fourth high period HP4 as an (n+3)-th gate signal Gn+3 in response to the (n+2)-th gate signal Gn+2. For example, the (n+3)-th gate signal Gn+3 of first and second horizontal periods overlaps the (n+2)-th gate signal Gn+2.

The (n+4) stage SRCn+4 receives the fifth clock signal CK5 and outputs the fifth clock signal CK5 of the fifth high period HP5 as an (n+4)-th gate signal Gn+4 in response to the (n+3)-th gate signal Gn+3. For example, the (n+4)-th gate signal Gn+4 of first and second horizontal periods overlaps the (n+3)-th gate signal Gn+3.

The (n+5) stage SRCn+5 receives the sixth clock signal CK6 and outputs the sixth clock signal CK6 of the sixth high period HP6 as an (n+5)-th gate signal Gn+5 in response to the (n+4)-th gate signal Gn+4. For example, the (n+5)-th gate signal Gn+5 of first and second horizontal periods overlaps the (n+4)-th gate signal Gn+4.

According to an exemplary embodiment, a middle part of each gate signal includes a U shape with a first depth in synchronization with the clock signal. The first depth corresponds to a voltage difference between the high voltage VON and the low voltage VSS. As shown in FIG. 3, the U shape includes straight lines connected to each other. The low voltage VSS may be equal to or different from the low voltage VOFF of the clock signal.

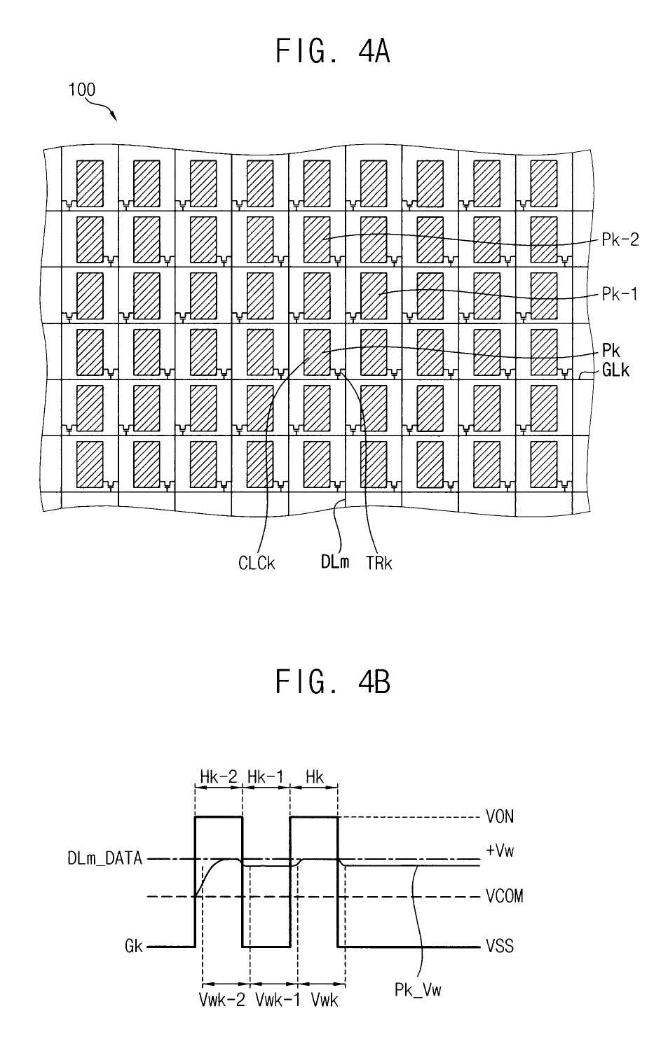

FIGS. 4A and 4B are diagrams schematically illustrating a charging rate of a pixel when a full white pattern is displayed on the display panel of FIG. 2.

Referring to FIGS. 4A and 4B, to display a full white pattern on the display panel 100, a white data voltage Vw corresponding to a white grayscale is applied to the display panel 100.

Hereinafter, a method of driving a k-th pixel Pk is described.

The k-th pixel Pk includes a k-th switching element TRk connected to an m-th data line DLm and a k-th gate line GLk, and a k-th liquid crystal (LC) capacitor CLCk connected to the k-th switching element TRk (m and k are natural numbers).

The white data voltage Vw having a first polarity (+) with respect to a common voltage VCOM is applied to the m data line DLm during a frame (DLm_DATA).

For example, a white data voltage Vwk−2 corresponding to a (k−2)-th pixel Pk−2 is applied to the m-th data line DLm during a (k−2)-th horizontal period Hk−2, a white data voltage Vwk−1 corresponding to the (k−1)-pixel Pk−1 is applied to the m-th data line DLm during a (k−1)-th horizontal period Hk−1, and a white data voltage Vwk corresponding to a k-th pixel Pk is applied to the m-th data line DLm during the k-th horizontal period Hk.

A k-th gate signal Gk is applied to a k-th gate line GLk. The k-th gate signal Gk has the high voltage VON during the (k−2)-th horizontal period Hk−2, the low voltage VSS during the (k−1)-th horizontal period Hk−1, the high voltage VON during the k-th horizontal period Hk, and the low voltage VSS during a remaining period of the frame except for the (k−2)-th, (k−1)-th, and k-th horizontal periods Hk−2, Hk−1, and Hk. The low voltage VSS may be equal to or different from the low voltage VOFF of the clock signal.

The k-th switching element TRk of the k-th pixel k charges the white data voltage Vw applied to the m-th data line DLm to the k-th LC capacitor CLCk in response to the k-th gate signal Gk.

Therefore, the k-th switching element TRk pre-charges the white data voltage Vwk−2 corresponding to the (k−2)-th pixel Pk−2 to the k-th LC capacitor CLCk in response to the high voltage VON of the k-th gate signal Gk during the (k−2)-th horizontal period Hk−2, maintains the white data voltage Vwk−2 charged to the k-th LC capacitor CLCk in response to the low voltage VSS of the k-th gate signal Gk during the (k−1)-th horizontal period Hk−1, and charges a self data voltage, which is the white data voltage Vwk, to the k-th LC capacitor CLCk in response to the high voltage VON of the k-th gate signal Gk during the k-th horizontal period Hk.

The k-th LC capacitor CLCk is pre-charged with a previous white data voltage during the (k−2)-th horizontal period Hk−2, maintains the charged white data voltage during the (k−1)-th horizontal period Hk−1, and is charged with the white data voltage during k-th horizontal period Hk (Pk_Vw).

The pixel voltage Pk_Vw charged to the k-th LC capacitor CLCk is decreased to a kickback voltage during the (k−1)-th horizontal period Hk−1 in which the k-th switching element TRk is turned off, but the white data voltage Vwk is recharged to the k-th LC capacitor CLCk during the k-th horizontal period Hk, which is a self charging period, so that a sufficient charging rate may be obtained.

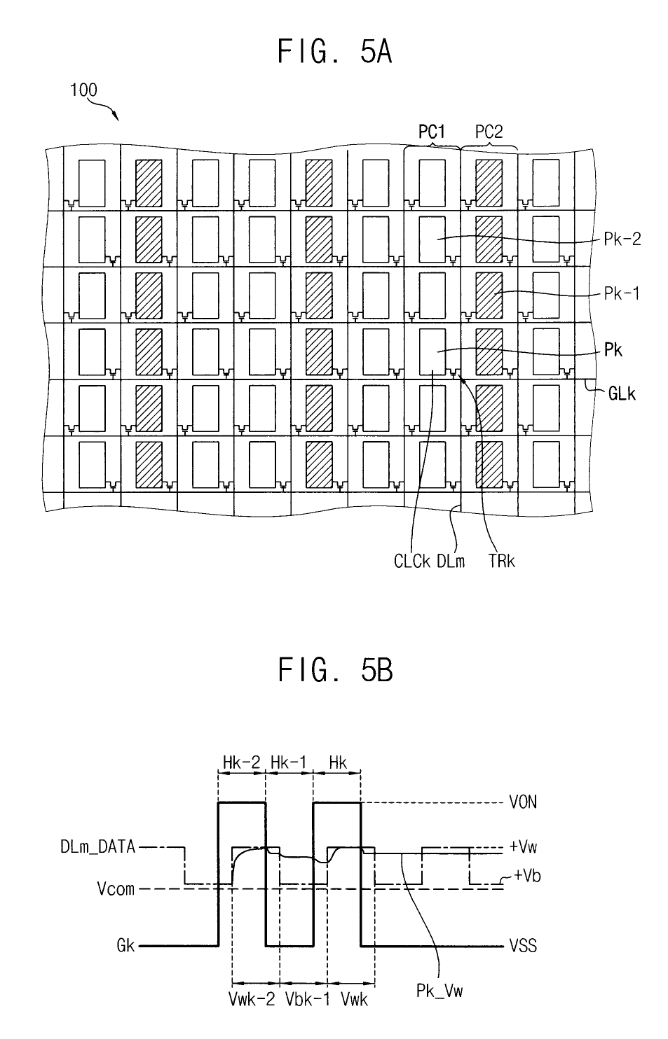

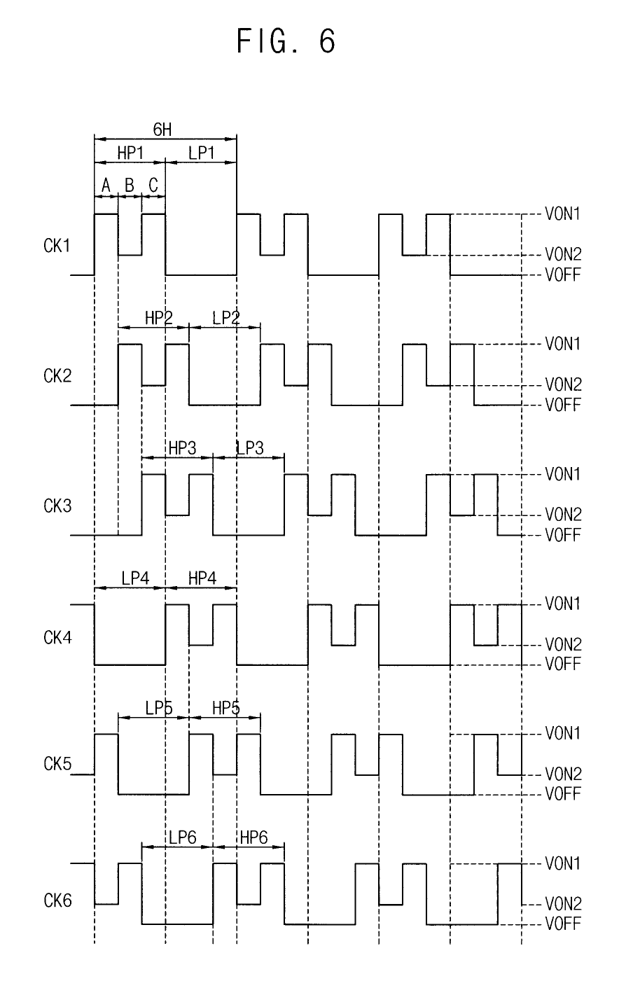

FIGS. 5A and 5B are diagrams schematically illustrating a charging rate of a pixel when a color pattern is displayed on the display panel of FIG. 2.

Referring to FIGS. 5A and 5B, to display a color pattern on the display panel 100, a white data voltage Vw corresponding to a white dray is applied to the data line connected to a preset color pixel of the display panel 100.

Hereinafter, a method of driving a k-th pixel Pk when a pixel column PC1 including the k-th pixel Pk connected to an m-th data line DLm and a k-th gate line GLk displays the color pattern is described.

The k-th pixel Pk includes a k-th switching element TRk connected to the m-th data line DLm and the k-th gate line GLk, and a k-th LC capacitor CLCk connected to the k-th switching element TRk.

The m-th data line DLm is disposed between the first pixel column PC1 and a second pixel column PC2, and alternately connected to pixels of the first pixel column PC1 and pixels of the second pixel column PC2. Thus, the white data voltage Vw and a black data voltage Vb are alternately applied to the m-th data line DLm for each horizontal (1H) period so that the white data voltage Vw is applied to the pixels of the first pixel column PC1 and the black data voltage Vb is applied to the pixels of the second pixel column PC2.

A white data voltage Vwk−2 corresponding to the (k−2)-th pixel Pk−2 of the first pixel column PC1 is applied to the m-th data line DLm during a (k−2)-th horizontal period Hk−2, a black data voltage Vbk−1 corresponding to a (k−1)-th pixel Pk−1 of the second pixel column PC2 is applied to the m-th data line DLm during a (k−1)-th horizontal period Hk−1, and a white data voltage Vwk corresponding to the k-th pixel Pk of the first pixel column PC1 is applied to the m-th data line DLm during a k-th horizontal period Hk.

A k-th gate signal Gk is applied to the k-th gate line GLk during the (k−2)-th horizontal period Hk−2, the (k−1)-th horizontal period Hk−1, and the k-th horizontal period Hk. The k-th gate signal Gk has the high voltage VON during the (k−2)-th horizontal period Hk−2, the low voltage VSS during the (k−1)-th horizontal period Hk−1, and the high voltage VON during the k-th horizontal period Hk, and has the low voltage VSS during the remaining period except for the (k−2)-th, (k−1)-th, and k-th horizontal periods Hk−2, Hk−1, and Hk of the frame.

The k-th switching element TRk of k-th pixel Pk charges the white data voltage Vw applied to the m-th data line DLm to the k-th LC capacitor CL/Ck in response to the k-th gate signal Gk.

The k-th switching element TRk pre-charges the white data voltage Vwk−2 corresponding to the (k−2)-th pixel Pk−2 to the k-th LC capacitor CLCk in response to the high voltage VON of the k-th gate signal Gk during the (k−2)-th horizontal period Hk−2, maintains the white data voltage Vwk−2 charged to the k-th LC capacitor CLCk in response to the low voltage VSS of the k-th gate signal Gk during the (k−1)-th horizontal period Hk−1, and charges the white data voltage Vwk to the k-th LC capacitor CLCk in response to the high voltage VON of the k-th gate signal Gk during the k-th horizontal period Hk (Pk_Vw).

As described above, the k-th gate signal Gk has the low voltage VSS during the (k−1)-th horizontal period Hk−1, so that the black data voltage Vbk−1 corresponding to the (k−1)-th pixel Pk−1 is prevented from being pre-charged to the k-th LC capacitor CLCk. Thus, a charging rate of the white data voltage Vwk that is a data voltage of the k-th pixel Pk during the k-th horizontal period Hk may be increased.

When the k-th gate signal Gk is the high voltage VON during the (k−1)-th horizontal period Hk−1, the black data voltage Vbk−1 is charged to the k-th LC capacitor CLCk. Thus, the charging rate of the white data voltage Vwk that is a self data voltage may decrease during the k-th horizontal period Hk.

According to an exemplary embodiment, a data voltage smaller than a self data voltage for a pixel is prevented from being charged to the pixel during a pre-charging period so that a charging rate of the self data voltage may increase.

FIG. 6 is a waveform diagram illustrating clock signals generated from a clock generating part according to an exemplary embodiment of the present invention.

Hereinafter, the same reference numerals may be used to refer to the same or substantially the same parts as those described in connection with FIGS. 1 to 5.

Referring to FIGS. 1 and 6, a clock generating part according to an exemplary embodiment generates first to sixth clock signals CK1, . . . , CK6.

The first clock signal CK1 includes a first high period HP1 and a first low period LP1. The first high period HP1 includes first, second, and third horizontal periods A, B, and C. The first clock signal CK1 has a first high voltage VON1 of a first level during the first horizontal period A, a second high voltage VON2 of a second level during the second horizontal period B, and the first high voltage VON1 of the first level during the third horizontal period C. The first clock signal CK1 has a low voltage VOFF of a third level during the first low period LP1. The second level of the second high voltage VON2 is a level between the first level of the first high voltage VON1 and the third level of the low voltage VOFF. The first high voltage VON1 turns on the switching element TR of the pixel P, and the low voltage VOFF turns off the switching element TR, and the second high voltage VON2 is less than a threshold voltage of the switching element TR so that the second high voltage VON2 turns off the switching element TR.

The second clock signal CK2 includes a second high period HP2 and a second low period LP2. The second high period HP2 includes the first, second, and third horizontal periods A, B, and C. The second clock signal CK2 has voltages VON1, VON2, and VON1 of the first, second, and first levels during the first, second, and third horizontal periods A, B, and C, respectively. The first and second horizontal periods A and B of the second clock signal CK2 respectively overlap the second and third horizontal periods B and C of the first clock signal CK1, and the third horizontal period C of the second clock signal CK2 overlaps part of the first low period LP1 of the first clock signal CK1.

The third clock signal CK3 includes a third high period HP3 and a third low period LP3. The third high period HP3 includes the first, second, and third horizontal periods A, B, and C. The third clock signal CK3 has voltages VON1, VON2, and VON1 of the first, second, and first levels during the first, second, and third horizontal periods A, B, and C, respectively. The first and second horizontal periods A and B of the third clock signal CK3 respectively overlap the second and third horizontal periods B and C of the second clock signal CK2, and the third horizontal period C of the third clock signal CK3 overlaps part of the second low period LP2 of the second clock signal CK2.

The fourth clock signal CK4 includes a fourth high period HP4 and a fourth low period LP4. The fourth high period HP4 includes the first, second, and third horizontal periods A, B, and C. The fourth clock signal CK4 has voltages VON1, VON2, and VON1 of the first, second, and first levels during the first, second, and third horizontal periods A, B, and C, respectively. The first and second horizontal periods A and B of the fourth clock signal CK4 respectively overlap the second and third horizontal periods B and C of the third clock signal CK3, and the third horizontal period C of the fourth clock signal CK4 overlaps part of the third low period LP3 of the third clock signal CK3. The fourth high period HP4 and the fourth low period LP4 respectively correspond to the first low period LP1 and the first high period HP1 of the first clock signal CK1.

The fifth clock signal CK5 includes a fifth high period HP5 and a fifth low period LP5. The fifth high period HP5 includes the first, second, and third horizontal periods A, B, and C. The fifth clock signal CK5 has voltages VON1, VON2, and VON1 of the first, second, and first levels during the first, second, and third horizontal periods A, B, and C, respectively. The first and second horizontal periods A and B of the fifth clock signal CK5 respectively overlap the second and third horizontal periods B and C of the fourth clock signal CK4, and the third horizontal period C of the fifth clock signal CK5 overlaps part of the fourth low period LP4 of the fourth clock signal CK4. The fifth high period HP5 and the fifth low period LP5 respectively correspond to the second low period LP2 and the second high period HP2 of the second clock signal CK2.

The sixth clock signal CK6 includes a sixth high period HP6 and a sixth low period LP6. The sixth high period HP6 includes the first, second, and third horizontal periods A, B, and C. The sixth clock signal CK6 has voltages VON1, VON2, and VON1 of the first, second, and first levels during the first, second, and third horizontal periods A, B and C, respectively. The first and second horizontal periods A and B of the sixth clock signal CK6 respectively overlap the second and third horizontal periods B and C of the fifth clock signal CK5, and the third horizontal period C of the sixth clock signal CK6 overlaps part of the fifth low period LP5 of the fifth clock signal CK5. The sixth high period HP6 and the sixth low period LP6 respectively correspond to the third low period LP3 and the third high period HP3 of the third clock signal CK3.

According to an exemplary embodiment, a middle part of each clock signal includes a U shape with a second depth. The second depth corresponds to a voltage difference between the first high voltage VON1 and the second high voltage VON2. As shown in FIG. 6, the U shape includes straight lines connected to each other.

The gate driving part according to an exemplary embodiment outputs a plurality of gate signals in synchronization with the high periods of the first to sixth clock signals CK1, . . . , CK6. According to an exemplary embodiment, a middle part of each gate signal includes a U shape with a second depth in synchronization with the clock signal. The second depth corresponds to a voltage difference between the first high voltage VON1 and the second high voltage VON2.

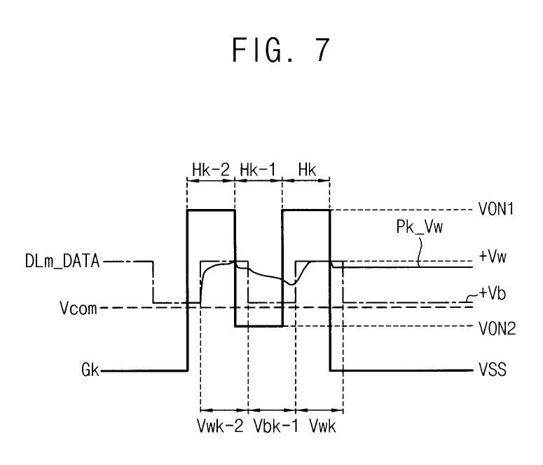

FIG. 7 is a waveform diagram illustrating a charging rate of a pixel according to a clock signal as shown in FIG. 6.

Referring to FIGS. 5A and 7, a method of driving a k-th pixel Pk when a pixel column PC1 including the k-th pixel Pk connected to an m-th data line DLm and a k-th gate line GLk displays a color pattern is described.

The k-th pixel Pk includes a k-th switching element TRk connected to the m-th data line DLm and the k-th gate line GLk and a k-th LC capacitor CLCk connected to the k-th switching element TRk.

The m-th data line DLm is disposed between a first pixel column PC1 and a second pixel column PC2, and alternately connected to pixels of the first pixel column PC1 and pixels of the second pixel column PC2. A white data voltage Vwk−2 corresponding to a (k−2)-th pixel Pk−2 of the first pixel column PC1 is applied to the m-th data line DLm during a (k−2)-th horizontal period Hk−2, a black data voltage Vbk−1 corresponding to a (k−1)-th pixel Pk−1 of the second pixel column PC2 is applied to the m-th data line DLm during a (k−1)-th horizontal period Hk−1, and the white data voltage Vwk corresponding to the k-th pixel Pk of the first pixel column PC1 is applied to the m-th data line DLm during a k-th horizontal period Hk.

The k-th gate signal Gk is applied to the k-th gate line GLk during the (k−2)-th horizontal period Hk−2, the (k−1)-th horizontal period Hk−1, and the k-th horizontal period Hk. The k-th gate signal Gk has the first high voltage VON1 during the (k−2)-th horizontal period Hk−2, the second voltage VON2 during the (k−1)-th horizontal period Hk−1, the first high voltage VON1 during the k-th horizontal period Hk, and the low voltage VSS during the remaining period except for the (k−2)-th, (k−1)-th, and k-th horizontal periods Hk−2, Hk−1 and Hk of the frame.

The k-th switching element TRk pre-charges the white data voltage Vwk−2 corresponding to the (k−2)-th pixel Pk−2 to the k-th LC capacitor CLCk in response to the first high voltage VON1 of the k-th gate signal Gk during the (k−2)-th horizontal period Hk−2, maintains the white data voltage Vwk−2 charged to the k-th LC capacitor CLCk in response to the second high voltage VON2 of the k-th gate signal Gk during the (k−1)-th horizontal period Hk−1, and charges the white data voltage Vwk to the k-th LC capacitor CLCk in response to the first high voltage VON1 of the k-th gate signal Gk during the k-th horizontal period Hk (Pk_Vw).

The second high voltage VON2 less than a threshold voltage of the switching element TRk is applied to the k-th switching element TRk during the (k−1)-th horizontal period Hk−1, so that the switching element TRk is turned off in response to the second high voltage VON2. The white data voltage Vwk−2 charged to the k-th LC capacitor CLCk decreases by a kickback voltage. Thus, during the k-th horizontal period Hk, the white data voltage Vwk is recharged to the k-th LC capacitor CLCk (Pk_Vw).

As described above, the k-th gate signal Gk has the second high voltage VON2 less than the threshold voltage during the (k−1)-th horizontal period Hk−1, so that the black data voltage Vbk−1 corresponding to the (k−1)-th pixel Pk−1 is prevented from being pre-charged to the k-th LC capacitor CLCk. Thus, a charging rate of the white data voltage Vwk that is a data voltage of the k-th pixel Pk may be increased during the k-th horizontal period Hk.

According to an exemplary embodiment, a data voltage smaller than a self data voltage for a pixel is prevented from being charged to the pixel during a pre-charging period, so that a charging rate of the self data voltage may increase. The k-th gate signal Gk has the second high voltage VON2 between the first high voltage VON1 and the low voltage VSS during the second horizontal period B so that a voltage change of the k-th gate signal Gk may decrease. Thus, a delay difference of the gate signal may decrease.

Table 1 shows pixel charging rates measured based on various gate signals according to an exemplary embodiment.

TABLE 1

| | DATA VOLTAGE: 14 V | |
|---|---|---|
| | Charged voltage (V)/ | Charged voltages (V)/ |
| | Charging rates | Charging rates |
| VON2 | of Pixel in Top-Right Area | of Pixel in Bottom-Right area |
| REF. (28 V) | 13.3 V/95% | 13 V/92.8% |
| 15 V | 13.3 V/95% | 13 V/92.8% |
| 19 V | 13.3 V/95% | 13 V/92.8% |
| 10 V | 13.4 V/95.7% | 13 V/93.5% |
| 0 V | 13.4 V/95.7% | 13 V/92.8% |
| −7 V | 13.5 V/96.4% | 13 V/92.8% |
| −12 V | 13.5 V/96.4% | 13.1 V/93.6% |

On condition that a driving frequency of the display panel is about 240 Hz, the first high voltage VON1 is about 28 V, the low voltage VSS is about −12 V, the first horizontal period A is about 2.9 μs, the second horizontal period B is about 3.4 μs, and the third horizontal period C is about 4.1 μs, the charged voltages and the charging rates of the pixel which is provided with the data voltage of about 14V according to a change of the second high voltage VON2 were measured.

Referring to Table 1, when the second high voltage VON2 is about 28V which is the same as the first high voltage VON1, the charged voltage and the charging rate of a pixel disposed in a top-right area of the display panel were respectively about 13.3V and about 95%, and the charged voltage and the charging rate of a pixel disposed in a bottom-right area of the display panel were respectively about 13V and about 92.8%.

Then, when the second high voltage VON2 is about 0V, the charged voltage and the charging rate of a pixel disposed in a top-right area of the display panel were respectively about 13.4V and about 95.7%, and the charged voltage and the charging ratio of a pixel disposed in a bottom-right area of the display panel were respectively about 13V and about 92.8%.

Then, when the second high voltage VON2 is about −12V, the charged voltage and the charging rate of a pixel disposed in a top-right area of the display panel were respectively about 13.5V and about 96.4%, and the charged voltage and the charging rate of a pixel disposed in a bottom right area of the display panel were respectively about 13.1V and about 93.6%.

According to Table 1, when the second high voltage VON2 is between the first high voltage VON1 and the low voltage VCS, the charged voltage and the charging rate increase in comparison with when the second high voltage VON2 is the first high voltage VON1(=28V). When the second high voltage VON2 is less than about 10V, the charged voltage and the charging rate are increased. When the second high voltage VON2 is about −12V, the charged voltage and the charging rate are the most in Table 1, which means that the charged voltage and the charging rate are the best in Table 1.

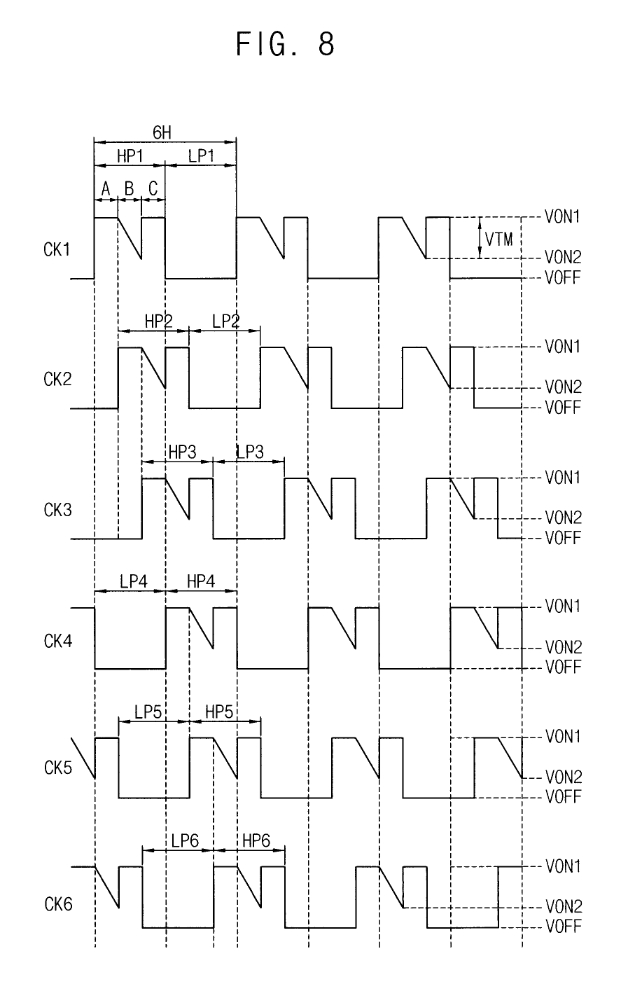

FIG. 8 is a waveform diagram illustrating clock signals generated from a clock generating part according to an exemplary embodiment of the present invention.

Referring to FIGS. 1 and 8, the clock generating part 250 generates first to sixth clock signals CK1, . . . , CK6.

The first clock signal CK1 includes a first high period HP1 and a first low period LP. The first high period HP1 includes first, second, and third horizontal periods A, B, and C. The first clock signal CK1 has a first high voltage VON1 of a first level during the first horizontal period A, a voltage VTM of a time modulation level gradually decreasing between the first high voltage VON1 of the first level and a second high voltage VON2 of a second level less than the first level during the second horizontal period B, and the first high voltage VON1 of the first level during the third horizontal period C. The first clock signal CK1 has a low voltage VOFF of a third level during the first low period LP1. The first high voltage VON1 turns on the switching element TR of the pixel P, and the low voltage VOFF turns off the switching element TR, and the time modulation level voltage VTM is less than a threshold voltage of the switching element TR so that the time modulation level voltage VTM turns off the switching element TR.

The second clock signal CK2 includes a second high period HP2 and a second low period LP2. The second high period HP2 includes the first, second, and third horizontal periods A, B and C. The second clock signal CK2 has voltages VON1, VTM, and VON1 of the first level, the time modulation level, and the first level during the first, second, and third horizontal periods A, B, and C, respectively. The first and second horizontal periods A and B of the second clock signal CK2 respectively overlap the second and third horizontal periods B and C of the first clock signal CK1, and the third horizontal period C of the second clock signal CK2 overlaps part of the first low period LP1 of the first clock signal CK1.

The third clock signal CK3 includes a third high period HP3 and a third low period LP3. The third high period HP3 includes the first, second, and third horizontal periods A, B, and C. The third clock signal CK3 has voltages VON1, VTM, and VON1 of the first level, the time modulation level, and the first level during the first, second, and third horizontal periods A, B, and C, respectively. The first and second horizontal periods A and B of the third clock signal CK3 respectively overlap the second and third horizontal periods B and C of the second clock signal CK2, and the third horizontal period C of the third clock signal CK3 overlaps part of the second low period LP2 of the second clock signal CK2.

The fourth clock signal CK4 includes a fourth high period HP4 and a fourth low period LP4. The fourth high period HP4 includes the first, second, and third horizontal periods A, B, and C. The fourth clock signal CK4 has voltages VON1, VTM, and VON1 of the first level, the time modulation level, and the first level during the first, second, and third horizontal periods A, B, and C, respectively. The first and second horizontal periods A and B of the fourth clock signal CK4 respectively overlap the second and third horizontal periods B and C of the third clock signal CK3, and the third horizontal period C of the fourth clock signal CK4 overlaps part of the third low period LP3 of the third clock signal CK3. The fourth high period HP4 and the fourth low period LP4 respectively correspond to the first low period LP1 and the first high period HP1 of the first clock signal CK1.

The fifth clock signal CK5 includes a fifth high period HP5 and a fifth low period LP5. The fifth high period HP5 includes the first, second, and third horizontal periods A, B, and C. The fifth clock signal CK5 has voltages VON1, VTM, and VON1 of the first level, the time modulation level, and the first level during the first, second, and third horizontal periods A, B, and C, respectively. The first and second horizontal periods A and B of the fifth clock signal CK5 respectively overlap the second and third horizontal periods B and C of the fourth clock signal CK4, and the third horizontal period C of the fifth clock signal CK5 overlaps part of the fourth low period LP4 of the fourth clock signal CK4. The fifth high period HP5 and the fifth low period LP5 respectively correspond to the second low period LP2 and the second high period HP2 of the second clock signal CK2.

The sixth clock signal CK6 includes a sixth high period HP6 and a sixth low period LP6. The sixth high period HP6 includes the first, second, and third horizontal periods A, B, and C. The sixth clock signal CK6 has voltages VON1, VTM, and VON1 of the first level, the time modulation level, and the first level during the first, second, and third horizontal periods A, B, and C, respectively. The first and second horizontal periods A and B of the sixth clock signal CK6 respectively overlap the second and third horizontal periods B and C of the fifth clock signal CK5, and the third horizontal period C of the sixth clock signal CK6 overlaps part of the fifth low period LP5 of the fifth clock signal CK5. The sixth high period HP6 and the sixth low period LP6 respectively correspond to the third low period LP3 and the third high period HP3 of the third clock signal CK3.

According to an exemplary embodiment, a middle part of each clock signal includes a V shape with a second depth. The second depth corresponds to a voltage difference between the first high voltage VON1 and the second high voltage VON2. As shown in FIG. 8, the V shape includes a straight line and a diagonal line connected to each other.

According to an exemplary embodiment, the gate driving part outputs a plurality of gate signals in synchronization with the high periods of the first to sixth clock signals CK1, . . . , CK6. According to an exemplary embodiment, a middle part of each gate signal includes the V shape with the second depth in synchronization with the clock signal. The second depth corresponds to a voltage difference between the first high voltage VON1 and the second high voltage VON2.

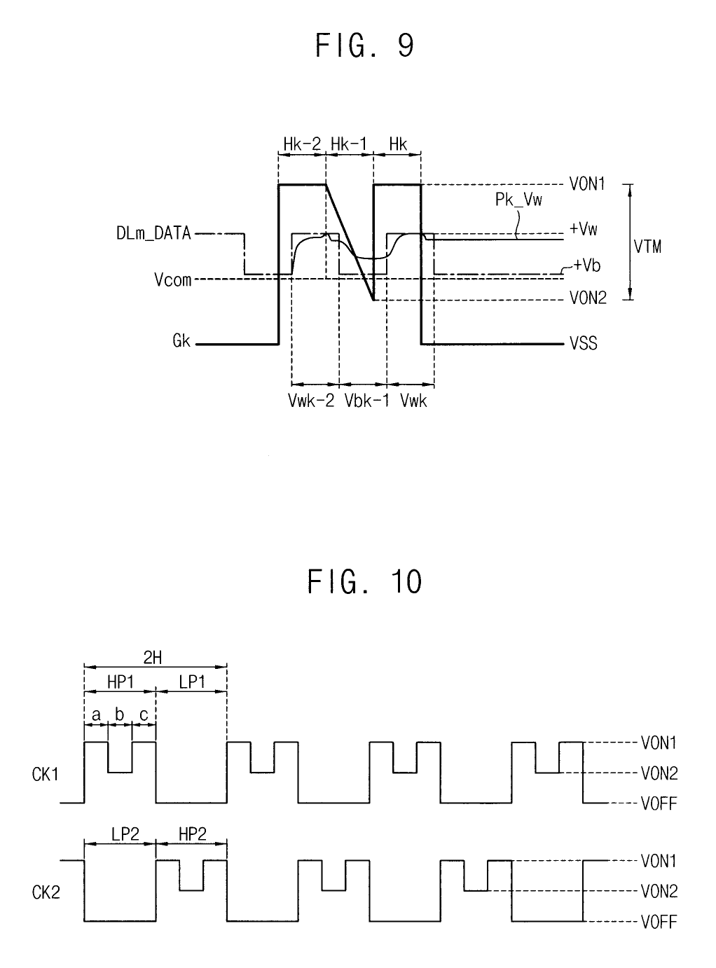

FIG. 9 is a waveform diagram illustrating a charging rate of a pixel according to a clock signal as shown in FIG. 8.

Referring to FIGS. 5A and 9, a method of driving a k-th pixel Pk when a pixel column PC1 including the k-th pixel Pk connected to an m-th data line DLm and a k-th gate line GLk displays a color pattern is described.

The k-th pixel Pk includes a k-th switching element TRk connected to the m-th data line DLm and the k-th gate line GLk and a k-th LC capacitor CLCk connected to the k-th switching element TRk.

The m-th data line DLm is disposed between a first pixel column PC1 and a second pixel column PC2, and alternately connected to pixels of the first pixel column PC1 and pixels of the second pixel column PC2.

Thus, a white data voltage Vwk−2 corresponding to a (k−2)-th pixel Pk−2 of the first pixel column PC1 is applied to the m-th data line DLm during a (k−2)-th horizontal period Hk−2, a black data voltage Vbk−1 corresponding to a (k−1)-th pixel Pk−1 of the second pixel column PC2 is applied to the m-th data line DLm during a (k−1)-th horizontal period Hk−1, and a white data voltage Vwk corresponding to the k-th pixel Pk of the first pixel column PC1 is applied to the m-th data line DLm during a k-th horizontal period Hk.

A k-th gate signal Gk is applied to the k-th gate line GLk during the (k−2)-th horizontal period Hk−2, the (k−1)-th horizontal period Hk−1, and the k-th horizontal period Hk. The k-th gate signal Gk has the first high voltage VON1 during the (k−2)-th horizontal period Hk−2, the time modulation voltage VTM during the (k−1)-th horizontal period Hk−1, the first high voltage VON1 during the k-th horizontal period Hk, and the low voltage VSS during the remaining period except for the (k−2)-th, (k−1)-th, and k-th horizontal periods Hk−2, Hk−1, and Hk of the frame.

The k-th switching element TRk pre-charges the white data voltage Vwk−2 corresponding to the (k−2)-th pixel Pk−2 to the k-th LC capacitor CLCk in response to the first high voltage VON1 of the k-th gate signal Gk during the (k−2)-th horizontal period Hk−2, maintains the white data voltage Vwk−2 charged to the k-th LC capacitor CLCk in response to the time modulation level voltage VTM of the k-th gate signal Gk during the (k−1)-th horizontal period Hk−1, and charges the white data voltage Vwk to the k-th LC capacitor CLCk in response to the first high voltage VON1 of the k-th gate signal Gk during the k-th horizontal period Hk (Pk_Vw). The time modulation level voltage VTM includes at least one of voltages time-modulated between the first high voltage VON1 and the second high voltage VON2 less than the first high voltage VON1.

The time modulation level voltage VTM is less than a threshold voltage of the k-th switching element TRk. Therefore, the switching element TR is turned off in response to the second high voltage VON2 so that the white data voltage Vwk−2 charged to the k-th LC capacitor CLCk decreases by a kickback voltage. Then, during the k-th horizontal period Hk, the white data voltage Vwk is recharged to the k-th LC capacitor CLCk (Pk_Vw).

As described above, the k-th gate signal Gk has the time modulation level voltage VTM less than the threshold voltage during the (k−1)-th horizontal period Hk−1, so that the black data voltage VBk−1 corresponding to the (k−1)-th pixel Pk−1 is prevented from being pre-charged to the k-th LC capacitor CLCk. Thus, a charging rate of the white data voltage Vwk that is a data voltage of the k-th pixel Pk may be increased during the k-th horizontal period Hk.

According to an exemplary embodiment, a data voltage smaller than a self data voltage for a pixel is prevented from being charged to the pixel during a pre-charging period so that a charging rate of the self data voltage may increase. The k-th gate signal Gk has the second high voltage VON2 between the first high voltage VON1 and the low voltage VSS during the second horizontal period B, so that a voltage change of the k-th gate signal Gk may decrease. Thus, a delay difference of the gate signal may decrease. In addition, current consumption may decrease so that a noise may be prevented from occurring at a high temperature.

FIG. 10 is a waveform diagram illustrating clock signals generated from a clock generating part according to an exemplary embodiment of the present invention.

Referring to FIGS. 1 and 10, a clock generating part according to an exemplary embodiment generates a first clock signal CK1 and a second clock signal CK2.

The first clock signal CK1 includes a first high period HP1 corresponding to 1H and a first low period LP1 corresponding to 1H. The first high period HP includes a first horizontal period a, a second horizontal period b, and a third horizontal period c. The first, second, and third horizontal periods a, b, and c may be equal to or different from each other.

The first clock signal CK1 has a first high voltage VON1 of a first level during the first horizontal period a, a second high voltage VON2 of the second level during the second horizontal period b, and the first high voltage VON1 of the first level during the third horizontal period c. The first low period LP1 has a low voltage VOFF of a third level. The first high voltage VON1 has a level turning on the switching element TR of the pixel P, and the low voltage VOFF has a level turning off the switching element TR of the pixel P. The second high voltage VON2 is preset to various voltages between the first high voltage VON1 and the low voltage VOFF.

The second clock signal CK2 includes a second high period HP2 and a second low period LP2. The second high period HP2 includes the first, second, and third horizontal periods a, b, and c. The first, second, and third horizontal periods a, b, and c of the second clock signal CK2 respectively have the same level as the first, second, and third horizontal periods a, b, and c of the first clock signal CK1. For example, the first, second, and third horizontal periods a, b, and c of the second clock signal CK2 have voltages VON, VOFF, and VON respectively corresponding to the first level, the second level, and the first level. The second high period HP2 and the second low period LP2 respectively correspond to the first low period LP1 and the first high period HP1 of the first clock signal CK1.

Each clock signal according to an exemplary embodiment has a middle part that includes the U shape with the first depth or the second depth, or the V shape with the first depth or the second depth as described in connection with FIGS. 2, 6, 8, and 9.

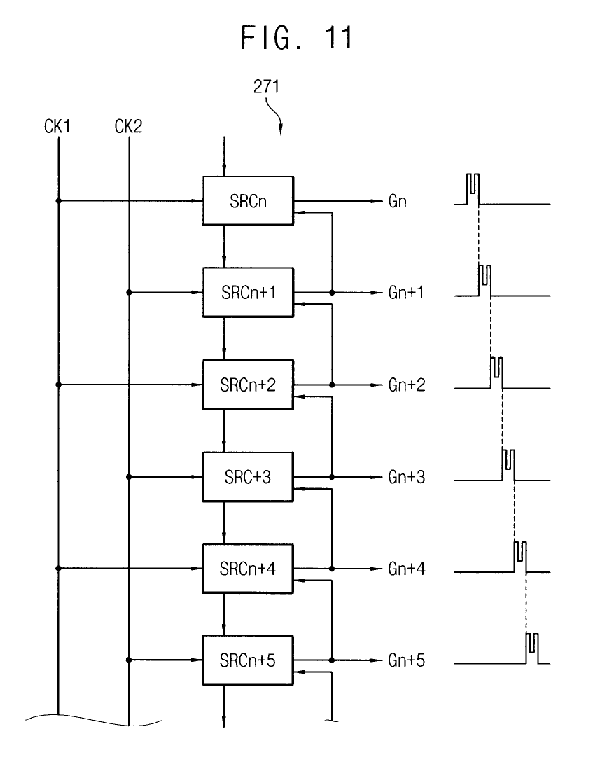

FIG. 11 is a block diagram illustrating a gate driving part according to an embodiment.

Referring to FIGS. 1, 10, and 11, a gate driving part 271 according to an exemplary embodiment includes a plurality of stages sequentially outputting a plurality of gate signals.

For example, the gate driving part 271 includes an n-th stage SRCn, an (n+1)-th stage SRCn+1, an (n+2)-th stage SRCn+2, an (n+3)-th stage SRCn+3, an (n+4)-th stage SRCn+4, and an (n+5)-th stage SRCn+5 and receives first and second clock signals CK1 and CK2.

The n-th stage SRCn receives the first clock signal CK1 and outputs the first clock signal CK1 of the first high period HP1 as an n-th gate signal Gn in response to a gate signal of a previous stage or a vertical starting signal.

The (n+1)-th stage SRCn+1 receives the second clock signal CK2 and outputs the second clock signal CK2 of the second high period HP2 as an (n+1)-th gate signal Gn+1 in response to the n-th gate signal Gn.

As described above, an odd-numbered stage of the gate driving part 271 outputs an odd-numbered gate signal in synchronization with the first clock signal CK1, and an even-numbered stage of the gate driving part 271 outputs an even-numbered gate signal in synchronization with the second clock signal CK2.

The gate driving part 271 may be used for a display panel, such as the display panel 100, having a structure in which each data line is alternately connected to pixels in a first pixel column and pixels in a second pixel column adjacent to the first pixel column. Alternatively, the gate driving part 271 may be used for a display panel having a structure in which each data line is connected to all pixels included in a pixel column.

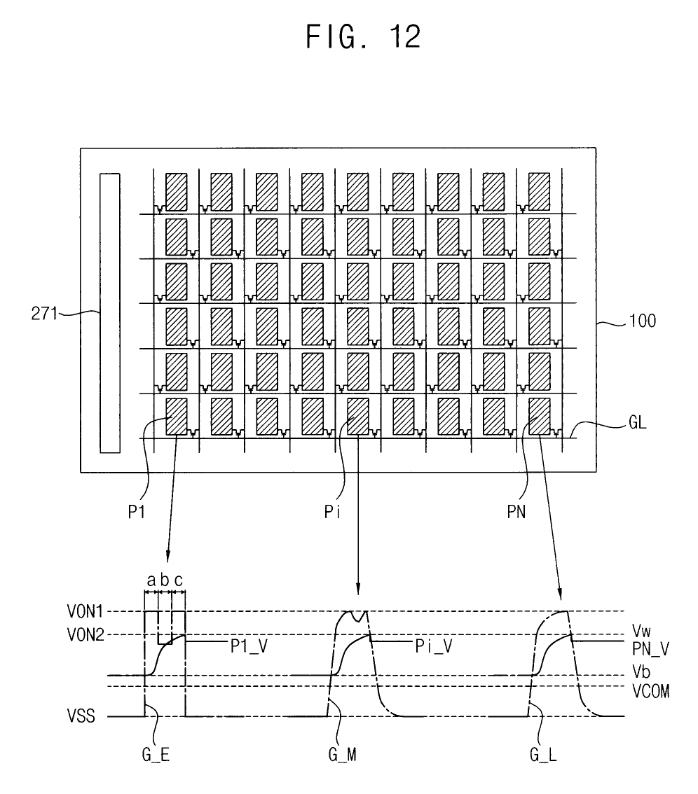

FIG. 12 is a waveform diagram illustrating a charging rate of a display panel according to the clock signals of FIG. 10.

Referring to FIGS. 10 and 12, charging rates corresponding to a first pixel P1, an i-th pixel Pi (i is a natural number), and an N-th pixel PN when a white data voltage Vw is applied to the display panel are described in an order of the pixels P1, Pi, and PN.

The gate driving part 271 generates a gate signal having the first high voltage VON1 during the first horizontal period a, the second high voltage VON2 during the second horizontal period b, and the first high voltage VON1 during the third horizontal period c in synchronization with the first or second clock signal CK1 or CK2 of a high period as shown FIG. 10.

The first pixel P1 is disposed closest to the gate driving part 271 and receives an early gate signal G_E which is generated from the gate driving part 271 and has a minimal RC delay as shown in FIG. 12. Thus, the first pixel P1 is charged with the white data voltage Vw during the first horizontal period a, maintains the white data voltage Vw charged to the first pixel P1 during the second horizontal period b, and is recharged with the white data voltage Vw during the third horizontal period c. A charging rate of the first pixel P may decrease in synchronization with the early gate signal G_E of the second horizontal period b (P1_V).

The i-th pixel Pi is disposed at a middle of the display panel 100 and receives a middle gate signal G_M which is generated from the gate driving part 271 and has a slight RC delay as shown in FIG. 12. The middle gate signal G_M has levels less than levels of the early gate signal G_E during the first and third horizontal periods a and c, but has a level more than a level of the early gate signal G_E during the second horizontal period b. Thus, the i-th pixel Pi is charged with the white data voltage Vw (Pi_V). In comparison with the first pixel P1, the charging rate of the white data voltage Vw charged to the i-th pixel Pi during the first horizontal period a may decrease, but the charging rate of the white data voltage Vw charged during the second horizontal period b may increase. As a consequence, the charging rate of the display panel 100 may be uniform.

The N-th pixel PN P1 is disposed farthest from the gate driving part 271 and receives a latter gate signal G_L which is generated from the gate driving part 271 and has a maximum RC delay as shown in FIG. 12. The latter gate signal G_L has levels less than levels of the early gate signal G_E during the first and third horizontal periods a and c, but has a level more than a level of early gate signal G_E during the second horizontal period b. Thus, the N-th pixel PN is charged with the white data voltage Vw (PN_V). In comparison with the first and i-th pixels P1 and Pi, the charging rate of the white data voltage Vw charged to the N-th pixel PN during the first horizontal period a may decrease, but the charging rate of the white data voltage Vw charged during the second horizontal period b may increase. Thus, the charging rate of the display panel 100 may be uniform.

According to the exemplary embodiments, the charging rate of the display panel 100 may be uniform, thus increasing display quality.

The foregoing is illustrative of the embodiments of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims.

What is claimed is:

1. A method of driving a display panel, the method comprising:
generating a clock signal including a high period which includes a first horizontal period having a first level, a second horizontal period having a second level smaller than the first level, and a third horizontal period having the first level, and a low period having a third level;
generating a gate signal which includes the first level in the first horizontal period, the second level in the second horizontal period, and the first level in the third horizontal period based on the clock signal; and
charging a data voltage to a pixel of the display panel in response to the gate signal.

2. The method of claim 1, wherein the first, second, and third horizontal periods are different from each other.

3. The method of claim 1, wherein the second horizontal period is the shortest of the first, second, and third horizontal periods.

4. The method of claim 1, wherein the second level includes at least one level between the first level and the third level.

5. The method of claim 1, wherein the second level and the third level are equal to each other.

6. The method of claim 1, wherein a middle part of the gate signal includes a U shape.

7. The method of claim 1, wherein a middle part of the gate signal includes a V shape.

8. The method of claim 1, wherein charging the data voltage comprises:
charging a previous data voltage corresponding to a previous horizontal period to the pixel in response to the first level of the gate signal during the first horizontal period;
maintaining the previous data voltage charged to the pixel the pixel in response to the second level of the gate signal during the second horizontal period; and
charging a self data voltage to the pixel in response to the first level of the gate signal during the third horizontal period.

9. The method of claim 1, wherein charging the data voltage comprises:
charging a self data voltage to the pixel in response to the first level of the gate signal during the first horizontal period;
maintaining the self data voltage charged to the pixel in response to the second level of the gate signal during the second horizontal period; and
recharging the self data voltage to the pixel in response to the first level of the gate signal during the third horizontal period.

10. A display apparatus comprising:
a clock generating part configured to generate a clock signal including a high period which includes a first horizontal period having a first level, a second horizontal period having a second level smaller than the first level, and a third horizontal period having the first level, and a low period having a third level;
a gate driving part configured to generate a gate signal which includes the first level in the first horizontal period, the second level in the second horizontal period, and the first level in the third horizontal period in synchronization with the clock signal; and
a display panel including a plurality of pixels arranged in a matrix shape, at least one of the pixels including a switching element connected to a data line and a gate line, wherein the switching element charges a data voltage to a liquid crystal (LC) capacitor in response to the gate signal.

11. The display apparatus of claim 10, wherein the data line is disposed between a first pixel column and a second pixel column adjacent to the first pixel column, and alternately connected to pixels of the first pixel column and pixels of the second pixel column.

12. The display apparatus of claim 10, wherein at least one of the first, second, and third horizontal periods is different from the other periods of the first, second, and third horizontal periods.

13. The display apparatus of claim 10, wherein the second horizontal period is the shortest of the first, second, and third horizontal periods.

14. The display apparatus of claim 10, wherein the second level includes at least one level which is smaller than the first level and equal to or larger than the third level.

15. The display apparatus of claim 10, wherein a middle part of the gate signal includes at least one of a U shape and a V shape.

16. The display apparatus of claim 10, wherein the clock generating part generates:
a first clock signal which includes a first high period including the first, second, and third horizontal periods and a first low period having the third level,
a second clock signal which includes a second high period including the first, second, and third horizontal periods and a second low period having the third level, the second high period overlapping part of the first high period,
a third clock signal which includes a third high period including the first, second, and third horizontal periods and a third low period having the third level, the third high period overlapping part of the second high period,
a fourth clock signal which includes a fourth high period including the first, second, and third horizontal periods and a fourth low period having the third level, the fourth high period overlapping part of the third high period and corresponding to the first low period,
a fifth clock signal which includes a fifth high period including the first, second, and third horizontal periods and a fifth low period having the third level, the fifth high period overlapping part of the fourth high period and corresponding to the second low period, and
a sixth clock signal which includes a sixth high period including the first, second, and third horizontal periods and a sixth low period having the third level, the sixth high period overlapping part of the fifth high period and corresponding to the third low period.

17. The display apparatus of claim 10, wherein the pixel is charged with a previous data voltage corresponding to a previous horizontal period in response to the first level of the gate signal during the first horizontal period, maintains the charged previous data voltage charged in response to the second level of the gate signal during the second horizontal period, and is charged with a self data voltage in response to the first level of the gate signal during the third horizontal period.

18. The display apparatus of claim 10, wherein the clock generating part generates a first clock signal which includes a first high period including the first, second, and third horizontal periods and a first low period having the third level and a second clock signal which includes a second high period including the first, second, and third horizontal periods and a second low period having the third level, wherein the second high period overlaps part of the first high period and corresponds to the first low period.

19. The display apparatus of claim 18, wherein the pixel is charged with a self data voltage in response to the first level of the gate signal during the first horizontal period, maintains the charged self data voltage in response to the second level of the gate signal during the second horizontal period, and is recharged with the self data voltage in response to the first level of the gate signal during the third horizontal period.

20. A display apparatus comprising:
a gate driving part generating a gate signal during a high period and a low period, wherein the high period includes first, second, and third horizontal periods, and the gate signal includes a first level during the first horizontal period, a second level during the second horizontal period, the first level during the third horizontal period, and a third level during the low period, wherein the second level is lower than the first level, and the third level is lower than the second level; and
a display panel including a plurality of pixels, wherein at least one of the pixels is connected to a data line and a gate line and is pre-charged with a data voltage from the data line during the first horizontal period, maintains the pre-charged data voltage during the second horizontal period, and is recharged with the data voltage during the third horizontal period in response to the gate signal from the gate line.
